(19) United States
(12) Patent Application Publication
(10) Pub. No.: US 2008/0191068 A1
(43) Pub. Date: Aug. 14, 2008

(54) Pulsed Electrostatic Atomiser

(75) Inventors: Jeffrey Allen, Norfolk (GB); Paul Bartholomew Ravenhill, Norfolk (GB)

Correspondence Address: LUEDEKA, NEELY & GRAHAM, P.C., P O BOX 1871, KNOXVILLE, TN, 37901, US

(73) Assignee: SCION SPRAYS LIMITED, Norwich (GB)

(21) Appl. No.: 11/575,339

(22) PCT Filed: Sep. 22, 2005
(86) PCT No.: PCT/GB05/03664

§ 371 Date: Mar. 15, 2007

(30) Foreign Application Priority Data
Sep. 25, 2004 (GB) 0421387.2

(51) Int. Cl. B05B 5/025

(52) U.S. Cl. 239/704

(57) ABSTRACT

An electrostatic atomizer comprises a fluid channel terminating in one or more orifices; means for controlling the flow of fluid out of the orifices; means for electrically charging fluid so that the fluid atomizes when it exits the or each orifice, wherein the atomizer further comprises control means which automatically pulse the flow ‘ON’ and ‘OFF’ and control means which automatically pulse the application of the charging voltage ‘ON’ and ‘OFF’, the ‘ON’ flow pulse and the ‘ON’ charging pulse being set to substantially coincide one with another, said control means switching electronically the charging voltage ‘ON’/‘OFF’.

### FIELD OF THE INVENTION

The invention relates to electrostatic atomisers. These may be employed in a large variety of fields for example in the supply of combustion fuel, liquid solutions in say the delivery of drugs, cosmetic fluids and other synthesised solutions in say household sprays. The invention as set out in this application is not limited to any of these particular applications and is intended to be applicable to any atomiser which falls within the scope of the claims which are included at the end of this specification.

### GENERAL BACKGROUND TO THE INVENTION

Many applications of atomisers require flow control of the fluid being atomised. Therefore to make use of electrostatic atomisation in these areas, pulse width modulated electrostatic atomisation is required. To achieve high levels of atomisation a high voltage potential is needed across the fluid in the charging area. If the fluid flow is stopped, the high potential applied will cause electrical breakdown of the fluid and result in electrical arcing through the fluid, which is detrimental causing: fluid disassociation, damage to the electrodes, carbon deposits and loss of electrical charge potential.

### PRIOR ART KNOWN TO THE APPLICANT(S)

The closest article of prior art is U.S. Pat. No. 5,234,170 (SCHIRMER et al) assigned to Robert Bosch GmbH at the time of publication which teaches the use of a fuel injection valve for controlling the flow of a fuel out of an injector whilst the position of the valve needle triggers the application of an electrostatic charge to a charging area located in the vicinity of the orifices of the injector. The power supplied for electrostatic charging of the fluid is a direct current supply which as shown in this prior art document is switched ON/OFF mechanically. The fluid injection of this prior art document will lag in time the sharp instantaneous initiation of electrostatic charge due to the fluids inertia. When the injector needle first rises from its seat in the fuel injection system shown, air would tend to fill the charging area first and only once the flow pressure difference is sufficient would fluid flow take place. Therefore injectors of this design are likely to suffer from detrimental electrical arcing or discharges inside the fluid charging area. Furthermore, the electrostatic atomiser of this prior art document has no flow and electrostatic control means whose pulse initiations may be varied for a variety of medium conditions.

Other prior art documents present injectors constructed and controlled to minimise the breakdown during atomisation. U.S. Pat. No. 5,297,738 (LEHR et al) similarly assigned to Robert Bosch GmbH does not envisage the use of any pulse width modulated charge or pulse width modulated flow. This prior art system attempts to limit electric breakdown by reducing the electrode potential by using mechanical swirl conduits. This prior art document therefore suggests to control breakdown primarily by mechanical means rather than electrical means.

In U.S. Pat. No. 2,227,465 and U.S. Pat. No. 6,206,307 (ARNOLD J. KELLY et al), an injector is presented and controlled to attempt to maximise atomisation by maximising charging potential without long term breakdown occurrences. This is achieved primarily by varying the charging voltage applied either on/off or in a cycle of high voltage values. There is no suggestion of pulsing the actual flow. There is in particular no mention of control means which precisely control the flow relative to the application of the charge. The actual embodiments focus on addressing the problems associated with long term breakdown in a steady state flow. There is also no mention of controlling the flow and the charging voltage in a conjoined manner.

None of the above prior art documents provides a solution to achieving initiations of atomisation of the kind shown in FIG. 1b from the initiation of atomisation. None of the prior art systems will avoid electrical breakdown in pulse width modulated primarily electrostatic systems.

### SUMMARY OF THE INVENTION

In a first broad independent aspect, the invention provides an electrostatic atomiser comprising a fluid channel terminating in one or more orifices; means of controlling the flow of fluid out of the orifices; means for electrically charging fluid so that the fluid atomises when it exits the or each orifice, wherein the atomiser further comprises control means which automatically pulse the flow “on” and “off” and control means which automatically pulse the application of the charging voltage “on” and “off”, the “on” flow pulse and the “on” charging pulse being set to substantially coincide one with another, the control means switching electrically the charging voltage “on”/“off”.

This configuration is particularly advantageous because it allows high levels of atomisation to be achieved from the initiation, during and at the end of the flow pulse. It will also have the advantages of minimising electric breakdown. Improved atomisation will of course reduce the risk of large drops forming instead of an even spread of atomised fluid. In a fuel combustion application, the conditions that lead to large drops formations cause excessive pollution and damage to the injectors but are avoided or largely mitigated with the inventive configuration.

In a subsidiary aspect in accordance with the invention's first broad independent aspect, the control means are configured so that the initiation of the charging pulse occurs immediately after the initiation of the fluid flow pulse. This unconventional sequence allows for the relative differences in initiation times for the flow relative to the application of the electrical charge. This will provide improved atomisation whilst mitigating or doing away altogether with the risk of damaging electrical discharge at the initiation phase of each pulse.

In a further subsidiary aspect, the control means are configured so that the termination of the charging pulse occurs immediately before the termination of the fluid flow pulse. This unconventional sequence of events also contributes to avoiding electrical breakdown at the latter stage of the fluid flow pulse.

In a further subsidiary aspect, the timing difference between either the respective pulse initiations or pulse terminations is of less than one hundred micro seconds. Below this figure, advantageous atomisation occurs whilst allowing high frequencies of fluid flow pulses to be achieved by the atomiser.

In a further subsidiary aspect, the control means causes the charging pulse to be formed of oscillations. This configuration also allows very rapid starts and stops for the high voltage charge supply.

In a further subsidiary aspect, the oscillations have a frequency ranging from 10-50 KHz. Within this range of oscillations particularly high levels of reliability of operation can be achieved.

The charging pulse may also be pulse width modulated.

In a further subsidiary aspect, the control means causes variable pulse durations to be applied. This unique feature over the prior art allows the electrostatic atomiser to be used in a wider variety of applications whilst preserving the advantages discussed above with reference to the previous inventive aspects.

In a further subsidiary aspect, the control means causes variable pulse frequencies to be applied. This is a unique feature in the context of the present art which will allow the atomiser to be used in a larger variety of applications other than those envisaged in the prior art.

In a further subsidiary aspect, the pulse frequencies range from two shots to 1 KHz.

In a second broad independent aspect in accordance with the invention, there is provided an electrostatic atomiser comprising a fluid channel terminating in one or more orifices; means of controlling the flow of fluid out of the orifices; means for electrically charging fluids so that the fluid atomises when it exits the or each orifice wherein said means for controlling the flow of fluid is configured to pulse between ON and OFF to either allow flow out of the or each orifice or prevent the flow from exiting the or each orifice and means are provided to circulate fluid from the position of charge application when the atomiser orifice flow is OFF.

This allows a steady state electrostatic charge and fluid flow to be applied for electrostatic charging purposes. In this configuration, the charge applied will dissipate during the circulation phase of the fluid. Atomisation will therefore occur immediately when the flow is directed towards the orifices without requiring an accurately time pulse start-up phase. Therefore the flow achieved from initiation and at the end of the flow will be of the kind shown in FIG. 1b.

Any subsidiary aspect in accordance with any of the previous aspects, the position of charge application and the flow control means are located in close proximity and a flow control valve is located externally from the orifices. This configuration will allow improved timing of the flow and electrostatic application pulses which will achieve improved atomisation.

In a further subsidiary aspect, the flow control means incorporate a valve which is combined with an electrode of the means for electrically charging fluid and the orifices of the atomiser are located in an essentially rounded sac, the tip of said electrode having a substantially similar shape so that the tip of the electrode fits inside the rounded sac. The conventional approach in electrostatic atomisers would be to use a conical electrode which would therefore not match the rounded sac. This configuration will improve further atomisation for certain applications.

In a further subsidiary aspect, the flow control means incorporate a valve and an electrode of the means for electrically charging fluid acts as the seat of the valve, a charging area being formed beneath the seat between said charging electrode and a wall having orifices which acts as a second electrode. This configuration will allow improved control of the flow and electrostatic pulses.

### BRIEF DESCRIPTION OF THE FIGURES

FIG. 1 shows two photographs A and B, both showing the flow of fluid at 0.3 ms after the start of the flow. 1A shows a flow without electrostatic charge whereas 1b show a flow out of the orifice with electrostatic charge being applied immediately after the start of the flow.

FIG. 2 shows an atomiser with a fluid control valve immediately preceding the electrostatic charging area in accordance with a first embodiment of the invention.

FIG. 3 shows a fluid flow control valve in close proximity to an area for electrostatically charging elements located beneath the valve seat in accordance with a second embodiment of the invention.

FIG. 4 shows an atomiser with a fluid flow control valve located externally from an injector in accordance with a third embodiment of the invention.

FIGS. 5a and 5b show the embodiments of FIGS. 2, 3 and 4 as flow charts summaries.

FIG. 6 shows a first method of operation of a pulsed frequency and width modulated atomiser.

FIG. 7 shows a second method of operation of a pulsed frequency and width modulated atomiser.

FIGS. 8a and 8b show control diagrams for the first and second mode methods of operations discussed with reference to FIGS. 6 and 7.

FIG. 9 shows an atomiser with a channel for circulating fluid out from the charging chamber when the fluid flow control valve is shut (a fourth embodiment of the invention).

FIG. 10 is a flow chart illustrative of the operation of the embodiment of FIG. 9.

FIG. 11 illustrates the control aspects of the embodiment of FIG. 9.

### DETAILED DESCRIPTION OF THE FIGURES

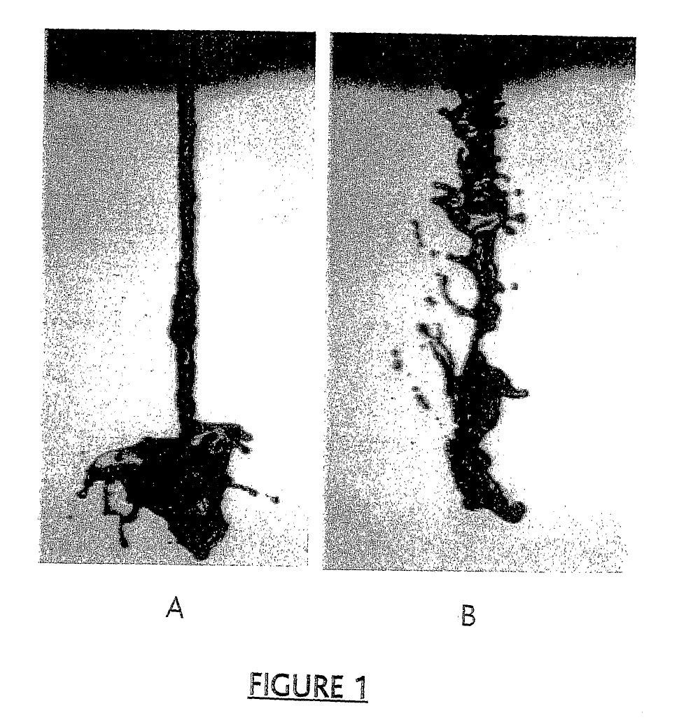

FIG. 1a shows a fuel jet without the high voltage being applied in the inventive manner. The jet has an initial narrow straight band and a large single drop at the farthermost extremity of the jet. The picture is taken 0.3 ms after the flow is initiated out of the orifice.

FIG. 1b shows a jet 0.3 ms after flow initiation with high atomisation due to the inventive control means of the invention. Details of embodiments which may achieve atomisation of the kind shown in FIG. 1b will now be described in detail.

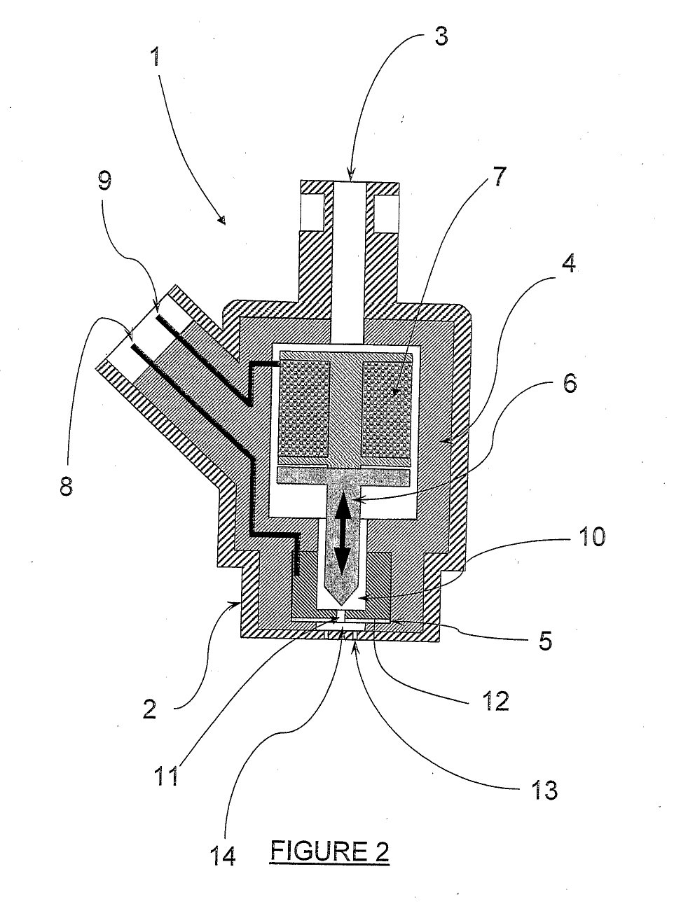

FIG. 2 shows an injector generally referenced 1 having a housing 2 which also acts as a ground electrode. The fluid or fuel inlet is located above the injector so that the fluid may be fed into the injector. Inside the outer housing 2 there is provided an insulating layer 4 which separates ground electrode 2 from an electrostatic electrode 5. Inside insulating layer 4 there is provided a valve pintle 6 whose position is controlled by a solenoid 7 and the control means driving the operation of the solenoid. The processing means controlling the operation of the electrode 5 and the solenoid 7 are not illustrated in the figure but are discussed in further detail at a later stage of this description. Traversing the insulation layer, there are provided electrical connectors 8 and 9 which respectively connect the solenoid 7 to appropriate processing means and electrode 5 to a current source.

Pintle 6 is configured to be displaceable within a narrow channel 10 towards and from electrode 5 which act as the valve seat so that when the solenoid causes the pintle to cover orifice 11 the flow is prevented from exiting the fluid/fuel passage. When the solenoid is energised, the pintle may be lifted (as shown in the figure) from its seat in order to allow the passage of fuel through orifice 11.

The electrostatic electrode 5 may comprise an array of faceted elements of the kind presented in the applicant's own previous patent application reference PCT/GB2004/000458 whose contents are enclosed in the present application by reference.

Below the faceted layer of electrode points, an electrostatic charging area 14 is formed between the electrode 5, the insulating layer 4 and an array of discharge orifices such as that referenced 13.

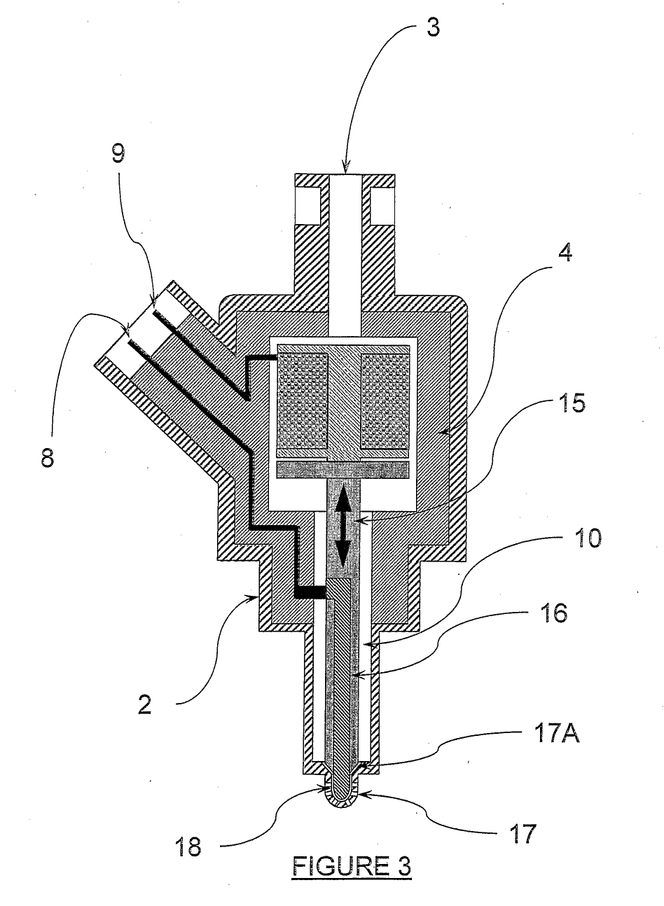

FIG. 3 shows an injector with similar features to the injector presented in FIG. 2. Identical features have retained identical reference numerals for simplicity. The valve of FIG. 3 also uses a solenoid operated pintle. Pintle 15 however has been modified to include radially inwards the electrostatic electrode 16. Electrode 16 terminates in an essentially rounded tip so as to substantially match a rounded multiple orifice sac 17.

The valve seat is formed in the embodiment by ground electrode 2 which has a tapered region 17A designed to correspond to a tapered portion of the pintle 15 so that when the pintle rests against the tapered portion of the ground electrode the flow of fuel is “off”. As discussed with reference to FIG. 2 when the solenoid is energised the pintle rises from the position shown in FIG. 3 in order to allow the flow between the tapered portions into an electrostatic charging area 18 located between the electrostatic electrode 16 and orifice sac 17. The invention also envisages that the pintle may act co-axially but be separate from the electrode.

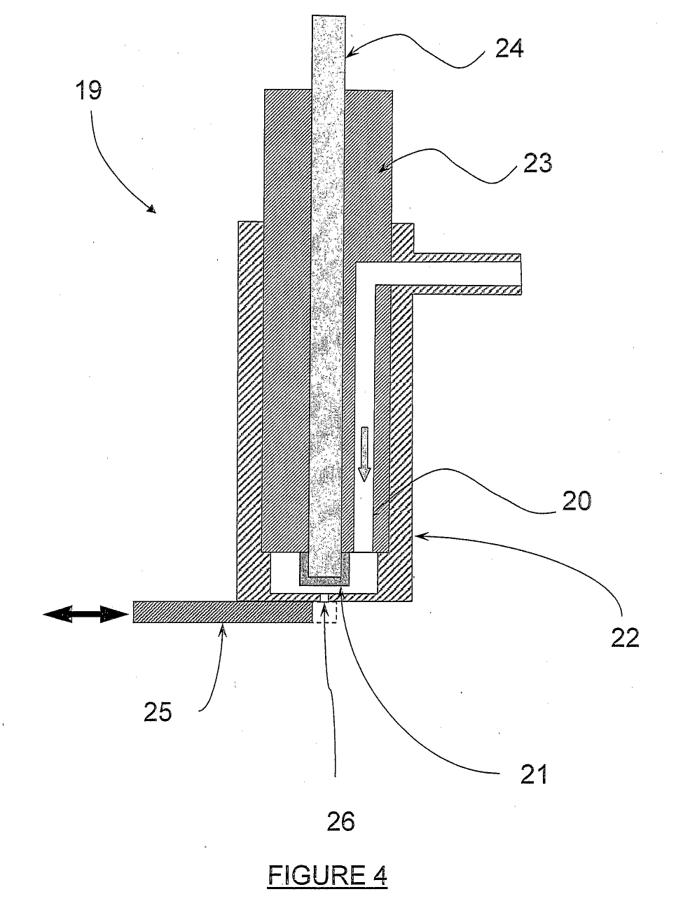

FIG. 4 shows a further embodiment of the invention in an injector generally referenced 19. Injector 19 is fed fluid such as a fuel from a lateral portion of the injector and down the injector through a fuel passage 20 and down into an electrostatic charging area 21 created between housing electrode 22, insulating material 23 and electrostatic electrode 24. The electrostatic electrode 24 is located centrally in the injector with a cylindrical tip extending outwards from the insulating material. The entire protruding portion of the electrostatic electrode is covered by an array of closely contiguous electrostatic points formed for example by an array of diamonds.

Externally from the housing of the injector, there is provided a fluid flow control valve 25 which may pivot or slide when appropriate over fuel spray discharge orifice 26 in order to control the flow out of the injector.

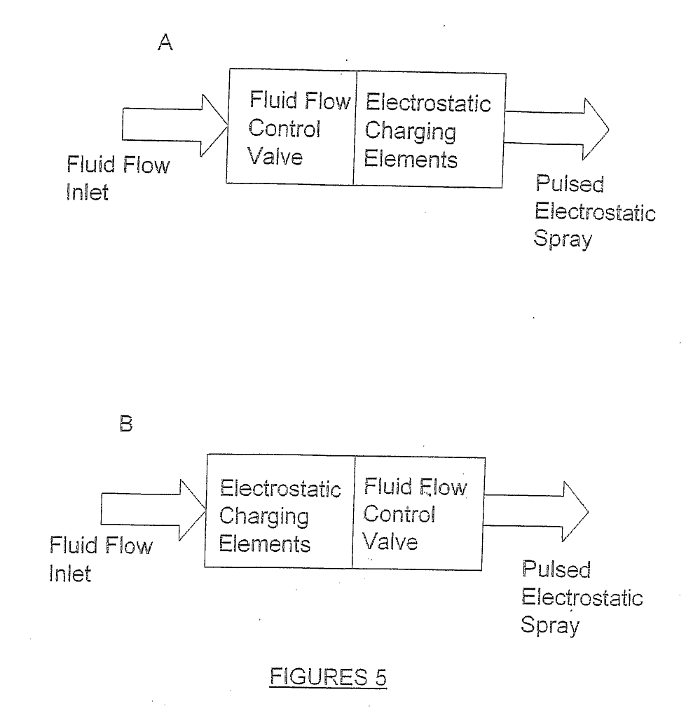

An aspect of the operation of the embodiments shown in FIG. 2 and FIG. 3 is illustrated in FIG. 5a in that the fluid flow control valve in both these figures is situated immediately before the electrostatic charging area. This close proximity arrangement has a number of benefits particularly in pulsed electrostatic spray applications.

FIG. 5b is illustrative of the disposition of the electrostatic charging elements vis a vis the fluid flow control valve in a system such as that shown in FIG. 4, where the electrostatic charging area immediately precedes the fluid flow control valve in the injector.

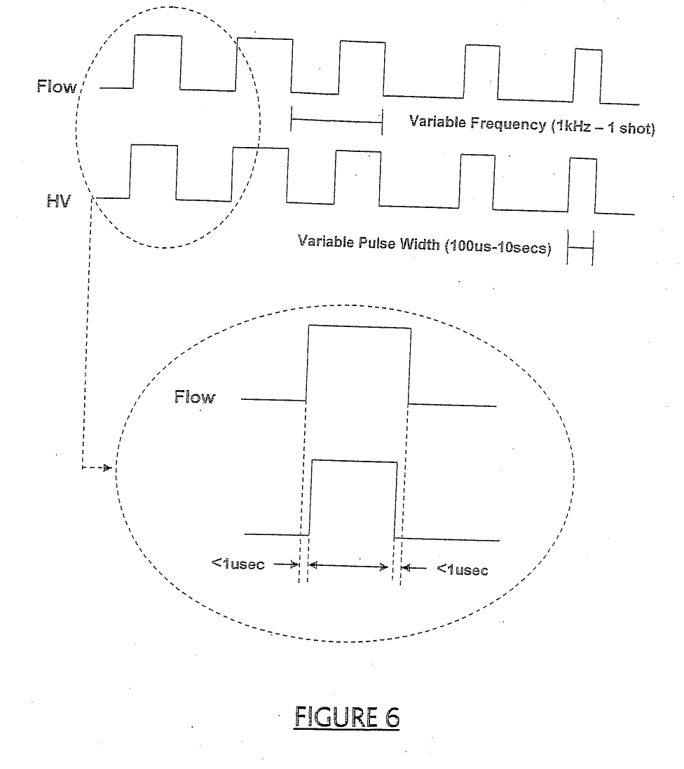

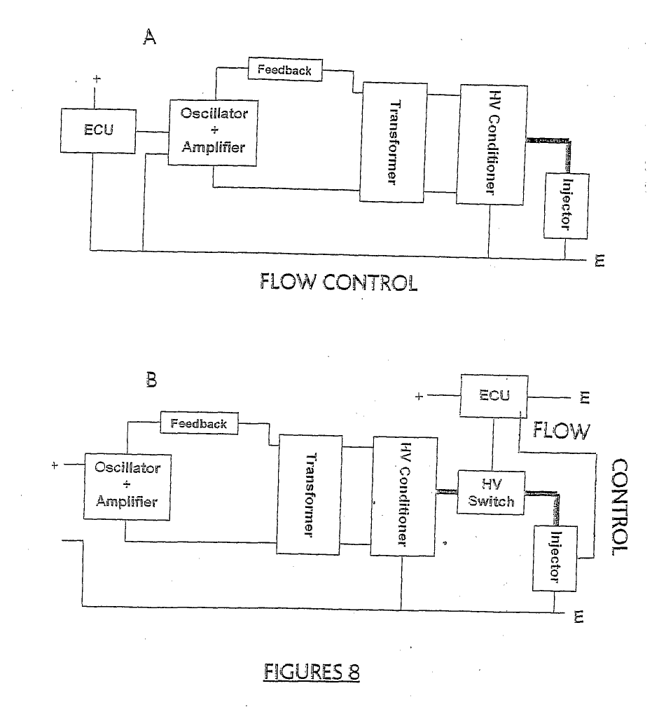

FIG. 6 shows the time pulse lines where the pulsed flow is substantially coincident with a pulsed application of high voltage. The processing means as will be discussed in further detail with reference to FIG. 8b may be said to vary the frequency of the flow with the frequency of the high voltage pulses. The processing means may also be used to vary the pulse width of the flow and high voltage in tandem.

The processing means may be set to initiate the high voltage pulse less than 1 micro second after the initiation of the flow pulse. Initiation of the flow is to be understood as the displacement of the actual flow after having overcome initial inertia. It is particularly when the flow starts to displace through the electrostatic chamber. The initiation of the flow is not be understood simply as being the opening of the valve. 1 micro second after the initiation of the actual flow in the chamber or out of the orifices, the high voltage is applied according to a particularly advantageous embodiment of the invention.

The control of both the flow and the high voltage relies on information stored in the engine control unit (ECU) for particular operating conditions. Characteristics such as fuel pressure, fuel type, fuel temperature, engine temperature and combustion chamber pressure are assessed by the ECU alongside the flow delay time for a given injector structure in order for the pintle or other flow valve to be lifted sufficiently in advance from the application of high voltage for the flow through the electrostatic chamber to have started. The ECU may have a detailed look up table for modifying the time between pintle action and application of charge as the characteristics of operation change throughout use.

Furthermore, the termination of the flow pulse may be said to occur less than 1 micro second after the termination of the high voltage pulse.

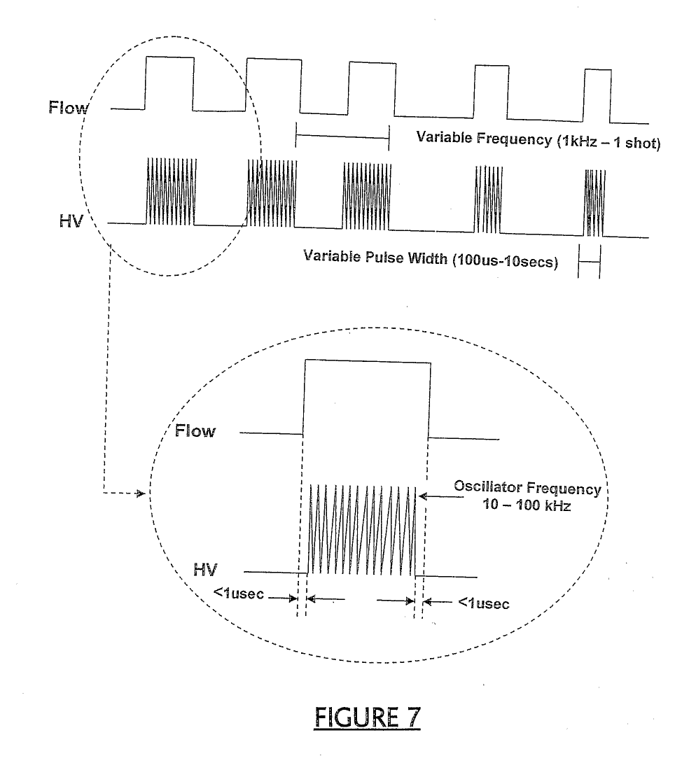

In this particular embodiment the high voltage pulses are direct current pulses. FIG. 7 illustrates the possibility of utilising high frequency oscillating voltage pulses. The high oscillator's frequency is preferably set between 10 and 100 KHz.

The control circuit in order to achieve oscillating high voltage pulses is presented in FIG. 8a which uses a high voltage conditioner to switch the oscillating high voltage pulses “on” and/or “off”.

FIG. 8b shows the particular control setup which may be used to achieve direct current high voltage pulses of the kind shown in FIG. 6. A high voltage switch will control the application of direct current voltage for atomisation. The engine control units (ECUs) in both FIGS. 8a and 8b are set to control flow and the high voltage conditioner and/or the high voltage switch in order to achieve substantially coincident pulses of flow and high voltage application.

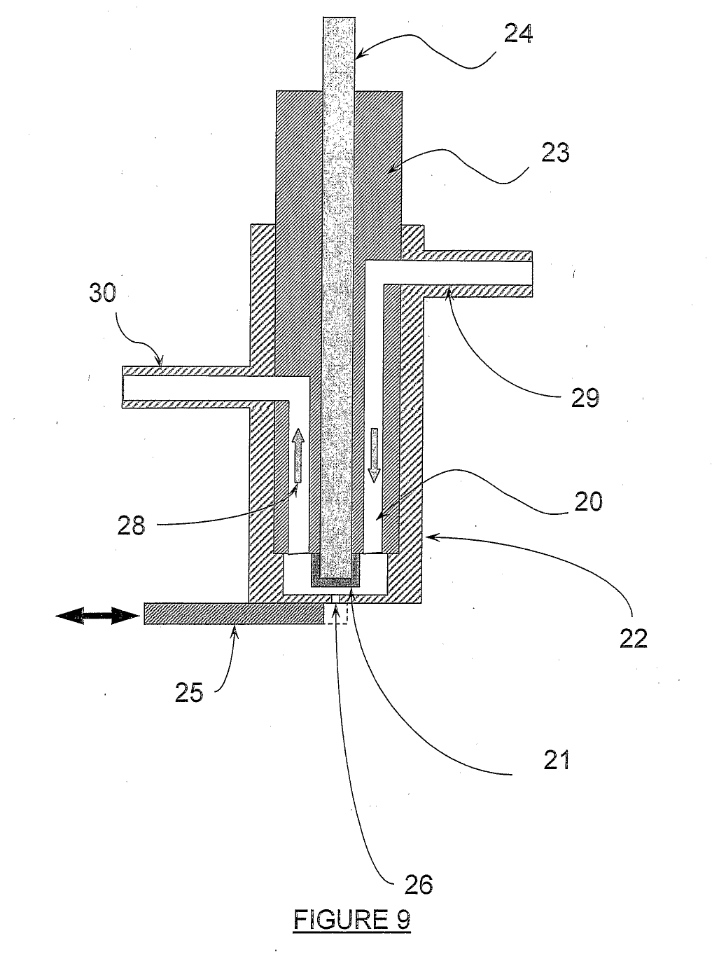

FIG. 9 shows a further injector generally referenced 27 having similar features to that illustrated with reference to FIG. 4. Similar features have been provided with similar numerical references for simplicity of description. The main difference being the provision of a fluid out-flow duct 28 which when the fluid flow control valve is “off”, allows the fluid entering through inlet duct 29 to circulate through the charging area 21 and out via fluid return ducts 28 and 30. As the fluid circulates in this manner the charge on it will be lost. However, charge is still applied at a continuous level at the charging area 21. When valve 25 opens at the (ON) stage, highly charged fluid immediately exits through orifice 26 with optimum atomisation.

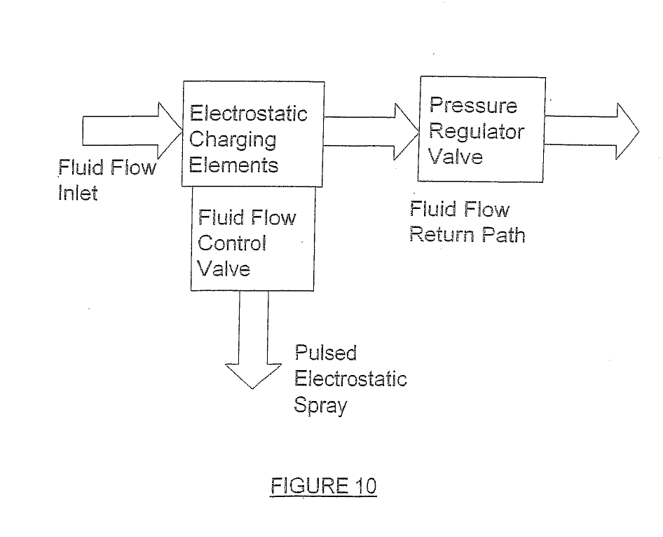

FIG. 10 shows the flow diagram of the mode of operation of the embodiment of FIG. 9. The charged elements may either be allowed to exit the orifices when the fluid flow control valve is open or to circulate and be submitted to a pressure regulator valve when the flow control valve is closed.

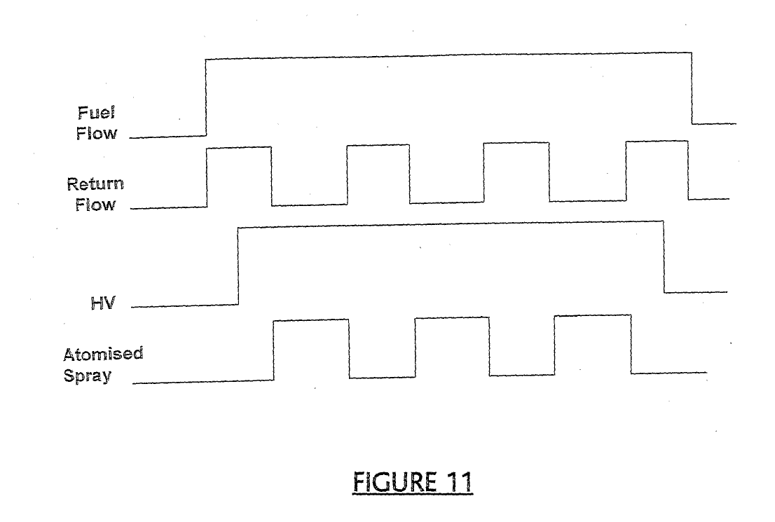

FIG. 11 shows the pulse line of the embodiment of FIG. 9. The fuel flow is steady state during a single pulse ie. either through the fluid return duct or out through the orifices. When the flow valve is open limited flow through the fluid return duct occurs. The high voltage is applied throughout. The flow valve achieves atomised spray from the moment it is open until the end of each pulse

1. An electrostatic atomiser comprising a fluid channel terminating in one or more orifices; means for controlling the flow of fluid out of the orifices: means for electrically charging fluid so that the fluid atomises when it exits the or each orifice, wherein the atomiser further comprises control means which automatically pulse the flow “ON” and “OFF” and control means which automatically pulse the application of the charging voltage “ON” and “OFF”, the “ON” flow pulse and the “ON” charging pulse being set to substantially coincide one with another, said control means switching electronically the charging voltage “ON”/“OF”, and said control means being configured so that the initiation of the charging pulse occurs immediately after the initiation of the flow pulse.

2. An electrostatic atomiser according to claim 1, wherein the control means are configured so that the termination of the charging pulse occurs immediately before the termination of the flow pulse.

3. (canceled)

4. An electrostatic atomiser according to claim 1, wherein the timing difference between either the respective pulse initiations or pulse terminations is of less than 100 micro seconds.

5. An electrostatic atomiser according to claim 1, wherein the control means causes the charging pulse to be formed of oscillations.

6. An electrostatic atomiser according to claim 6, wherein the oscillations have a frequency ranging from 10 to 50 KHz.

7. An electrostatic atomiser according to claim 1, wherein the control means causes variable pulse widths to be applied.

8. An electrostatic atomiser according to claim 1, wherein the control means causes variable pulse frequencies to be applied.

9. An electrostatic atomiser according to claim 8, wherein the pulse frequencies range from two shots to 1 KHz.

10. An electrostatic atomiser comprising a fluid channel terminating in one or more orifices; means for controlling the flow of fluid out of the orifices; means for electrically charging fluid so that the fluid atomises when it exits the or each orifice wherein said means for controlling the flow of fluid is configured to pulse between ON and OFF to either allow flow out of the or each orifice or prevent the flow from exiting from the or each orifice and means are provided to circulate fluid from the position of charge application when the atomiser orifice flow is OFF.

11. An electrostatic atomiser according to claim 1, wherein the position of charge application and the flow control means are located in close proximity and a flow control valve is located externally from the orifices.

12. An electrostatic atomiser according to claim 1, wherein the flow control means incorporate a valve which is combined with an electrode of the means for electrically charging fluid and the orifices of the atomiser are located in an essentially rounded sac, the tip of said electrode having a substantially similar tip shape so that the tip of the electrode fits inside the rounded sac.

13. An electrostatic atomiser according to claim 1, wherein the flow control means incorporate a valve and an electrode of the means for electrically charging fluid acts as the seat of the valve, a charging area being formed beneath the seat between said charging electrode and a wall having orifices which acts as a second electrode.

14. (canceled)
